(19) United States
(12) Patent Application Publication
(10) Pub. No.: US 2008/0179859 A1
(43) Pub. Date: Jul. 31, 2008

(54) Motorcycle foot peg and boot cleat assembly

(76) Inventors: Steven L. Boehmke, Orange, CA (US); Frank Hermansen, Laguna Beach, CA (US); Carl Winefordner, Laguna Beach, CA (US); Andrew Herrick, Laguna Beach, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 11/657,751

(22) Filed: Jan. 25, 2007

(51) Int. Cl. B62J 25/00

(52) U.S. Cl. 280/291; 36/131

(57) ABSTRACT

A motorcycle foot peg is comprised of a shaft connected to a bracket via a pin and a cotter pin, a platform, an outer and inner latch, a spring, and a screw. A platform swivels on the shaft. The spring biases the outer latch to be held substantially perpendicular to the inner latch, and swivels on the shaft. When mounted to a motorcycle frame, the foot peg enables a motorcycle rider to fixedly engage their feet into the foot peg via fore and aft cleats on the bottom of their motorcycle boots. To release from the foot peg, the rider twists their boots past a certain angle. The platform pivots to expose either side of the platform and make proper contact between the bottom of the boot and the platform. Platform teeth give grip between the boot and the platform when rider is not engaged to the foot peg. A shaft leg prevents the foot peg from pivoting up and back relative to the motorcycle frame. A first cleat is mounted towards the front of a motorcycle boot and a second cleat rearward from the first. Screws secure cleats to the bottom of the motorcycle boot. Slots allow the cleat to be adjusted fore and aft. A rider clips into the forward cleat in order to absorb bumps in the terrain, and clips into the rearward cleat in order to operate the gear shift lever or operate the foot brake. For longer rides for comfort, it may be desirable to switch between being clipped into the forward and rearward cleats.

### BACKGROUND OF THE INVENTION

1. Field of the Invention

This invention relates to motorcycles and more particularly to an improvement in foot pegs for motorcycles, including two and three wheeled motorcycles and also four wheeled all terrain vehicles which are ridden in a manner similar to motorcycles.

2. Background Art

As is well-known, most motorcycle assemblies include a frame having a seat on which a rider sits in a straddle fashion. Foot pegs are carried at the lower end of the frame at opposite sides thereof for the rider to place his feet when riding. Frequently, controls for operating certain components of the motor cycle, such as a rear wheel brake or gear shift, are located in close proximity to the foot pegs. This allows the operator to foot activate the controls when desirable.

It is common for motorcycle foot pegs to vary in appearance depending on intended application. Overall their basic design remains the same, that is, they provide a fixed projection in an appropriate position for the support of the rider's feet.

The design of the conventional motorcycle foot peg has some inherent disadvantages. For example, motorcycle foot pegs only provide a surface to stand on, and do not prevent the rider's feet from pulling off of the pegs. In some types of riding, the rider must currently use their thighs to tightly grip the sides of the seat and tightly hang on to the handlebars in order to not lose contact with the pegs and to keep from being thrown off the motorcycle. Especially on longer rides, this is tiring for the rider's legs, hands, and arms, and causes strain on the rider's neck and back. The rider may need to take frequent breaks off the motorcycle to prevent cramping. Furthermore, it can be dangerous if the rider loses grip and his feet lose contact with the pegs.

There are many different types of motorcycle riding such as street sport, street cruisers, off-road, enduro, and stunts. Motorcycle pegs either have a fixed platform to stand on or a platform that swivels. In U.S. Pat. No. 6,663,129, Smith describes a peg that has a body portion that is partially rotatable about a shaft. Stops prevent the body from pivoting past certain positions. Smith's peg does not provide any means of retaining a boot onto the peg.

It is a principal object of this invention to provide an improved foot peg for motorcycles.

It is a further object of this invention to provide a foot peg for motorcycles that clips the rider onto the pegs to improve control, prevent loss of contact with the pegs, reduce stress on the rider's body, and expand the stunts that are possible.

It is a further object of this invention to provide a motorcycle boot that has one or more cleats mounted on the bottom for clipping into a motorcycle foot peg.

### SUMMARY OF THE INVENTION

The invention, in its broadest aspect includes a foot peg for a motorcycle which has a mechanism for clipping the boot to the peg. There are many advantages to such a system.

As is well-known in bicycling, there are numerous advantages in clipping shoes into pedals. In bicycling, clipping into the pedals allows the rider to pull upwards while pedaling, allowing for a more powerful and efficient ride. Secondly, being clipped into the pedals also allows the rider to more easily “bunny hop” over depressions in the road by pulling up on the pedals and lifting the bicycle off the ground. Thirdly, clipping into pedals provides the rider with confidence that their feet will remain on the pedals. Fourthly, clipping into pedals reduces body stress and allows for a more relaxed and controlled ride. There are additional advantages of clipping into pedals for off-road bicycling including enabling certain stunts, remaining on the pedals while jumping in the air, and improving control of the bicycle both up and down hills.

Currently, the majority of all bicycle enthusiasts find that using pedals that they can clip into is essential for most forms of bicycle riding such as road, downhill, cross country, free ride, BMX, Enduro, and commuting. The same will follow for the different types of motorcycle riding.

The term “bunny hop” comes from the motion of a rider compressing his legs and body, then lunging forward like a rabbit. This motion may be described as winding back and springing upwards and forward to hop over an obstacle. Clipping into pegs allows a motorcyclist to bunny hop, something that they otherwise cannot do. There are many situations where it would be especially advantageous to bunny hop a motorcycle over an irregularity in the road or trail.

Clipping into motorcycle pegs, however, provides a new set of challenges beyond clipping into bicycle pedals. Motorcycles typically have a shift lever on one side and a foot brake on the other side. In order to activate the shifter and brake, the motorcycle rider would need to have their boot cleat much farther back than a bicycle rider. However, when not braking or shifting, a motorcycle rider often prefers to stand with the peg under the ball of their toes, as this position is more comfortable and allows the rider's body to soak up larger bumps in the road with their legs.

There are many differences between the requirements of a motorcycle peg and a bicycle pedal. Motorcycles are far heavier, far more powerful, bigger, faster, and motorcyclist's legs and feet are more stationary. Unlike a bicycle pedal, there should be at least two cleats per boot for motorcycle use. Unlike bicycling, the peg must be built especially strong to withstand the rigors of motorcycling and to enable higher pulling loads. A motorcycle typically weighs 10 to 20 times more than a bicycle, and so it is possible to apply much higher loads on a motorcycle peg clipping cleat and mechanism than on a bicycle pedal. A motorcyclist often uses a knee high boot that is stiff and large, whereas a bicyclist often uses a light weight low rise shoe. Motorcycle pegs often pivot up and out of the way. Motorcycle pegs are in a relatively fixed position on the motorcycle, whereas bicycle pedals rotate on crank arms.

Many off-road motorcyclists also ride mountain or BMX bikes, and so are already familiar with clipping into pedals. The learning curve for these motorcyclists will be especially short.

The invention provides a foot peg and boot for motorcycles that allows the rider to clip in securely. This gives the motorcycle rider more control, less fatigue, more stunts, the ability to bunny hop the motorcycle, and less body stress. This extra assistance helps the rider to conserve energy and reduce fatigue and therefore retain a higher level of concentration.

### BRIEF DESCRIPTION OF THE DRAWINGS

The aforementioned objects and advantages of the present invention, as well as additional objects and advantages thereof will be more fully understood hereinafter, as a result of a detailed description of preferred embodiments thereof, when taken in conjunction with the following drawings in which:

FIG. 1 is a perspective view of a motorcycle foot peg assembly in accordance with the preferred embodiment;

FIG. 2 is a top view of the motorcycle foot peg assembly in accordance with the preferred embodiment;

FIG. 3 is a back view of the motorcycle foot peg assembly shown FIG. 2;

FIG. 4 is a bottom view of the motorcycle foot peg assembly shown FIG. 2;

FIG. 5 is an end view of the motorcycle foot peg assembly shown FIG. 2;

FIG. 6 is a cross sectional view of the motorcycle foot peg assembly shown in FIG. 5;

FIG. 7 is a perspective view of a boot cleat for use with the motorcycle foot peg assemblies;

FIG. 8 is a perspective view of the motorcycle foot peg assembly with the boot cleat clipped into the mechanism;

FIG. 9 is a top view of the motorcycle foot peg assembly and boot cleat shown FIG. 8;

FIG. 10 is an end view of the motorcycle foot peg assembly and boot cleat shown FIG. 8;

FIG. 11 is a bottom view of an alternative embodiment motorcycle foot peg assembly;

FIG. 12 is an inverted side view of the alternative embodiment motorcycle foot peg assembly shown in FIG. 11;

FIG. 13 is a perspective view of the alternative embodiment motorcycle foot peg assembly shown in FIG. 11;

FIG. 14 is a side view of the alternative embodiment motorcycle foot peg assembly shown in FIG. 11;

FIG. 15 is a perspective view of another alternative embodiment motorcycle foot peg assembly;

FIG. 16 is a side view of the alternative embodiment motorcycle foot peg assembly shown in FIG. 15;

FIG. 17 is a top view of the alternative embodiment motorcycle foot peg assembly shown in FIG. 15;

FIG. 18 is an end view of the alternative embodiment motorcycle foot peg assembly shown in FIG. 15; and

FIG. 19 is a perspective view of a motorcycle boot with cleats for use with the motorcycle foot peg assemblies hereof.

The description herein refers to reference numerals in the accompanying drawings and these reference numerals refer to the parts therein having the following definitions:

### REFERENCE NUMERALS IN DRAWINGS

10 motorcycle foot peg
20 alternative embodiment
30 alternative embodiment
40 right motorcycle boot
42 slot
44 buckle
46 buckle
48 buckle
52 buckle
54 tread
55 upper
56 slot
57 sole
58 tread
60 left motorcycle boot
70 cleat
80 bracket
82 hole
84 hole
90 shaft
92 stop
94 support
100 screw
110 outer latch
112 bar
120 inner latch
122 bar
130 spring
140 platform
142 tooth
160 pin
170 platform
172 tooth
174 tab
176 tab
180 shaft
182 support
184 stop
186 stop
190 latch
200 spring
210 screw
220 cotter pin
230 cleat
232 tip
234 tip
236 top
238 bottom
242 pins
244 hole
250 latch

### DETAILED DESCRIPTION OF PREFERRED EMBODIMENT

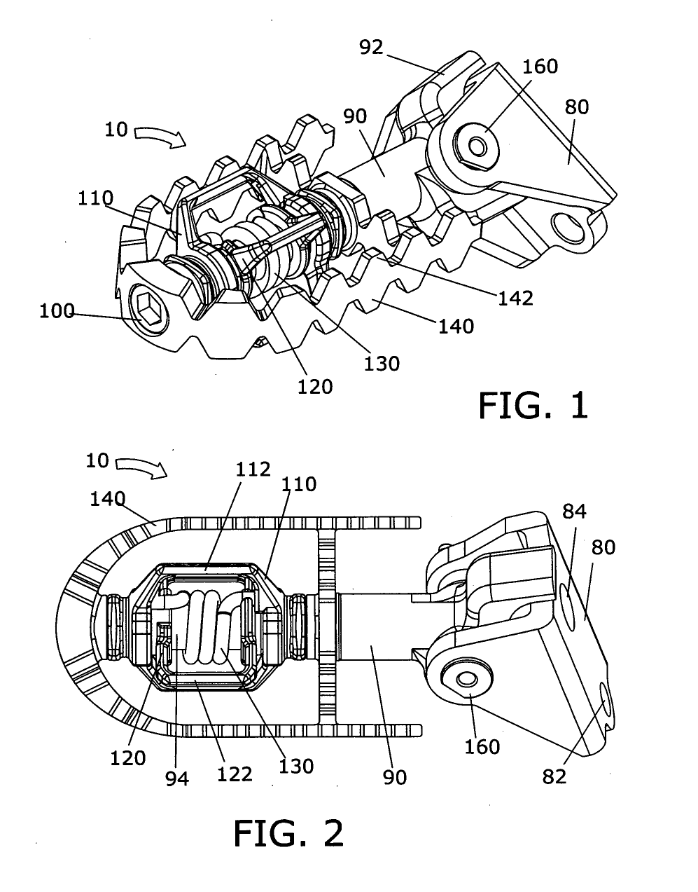

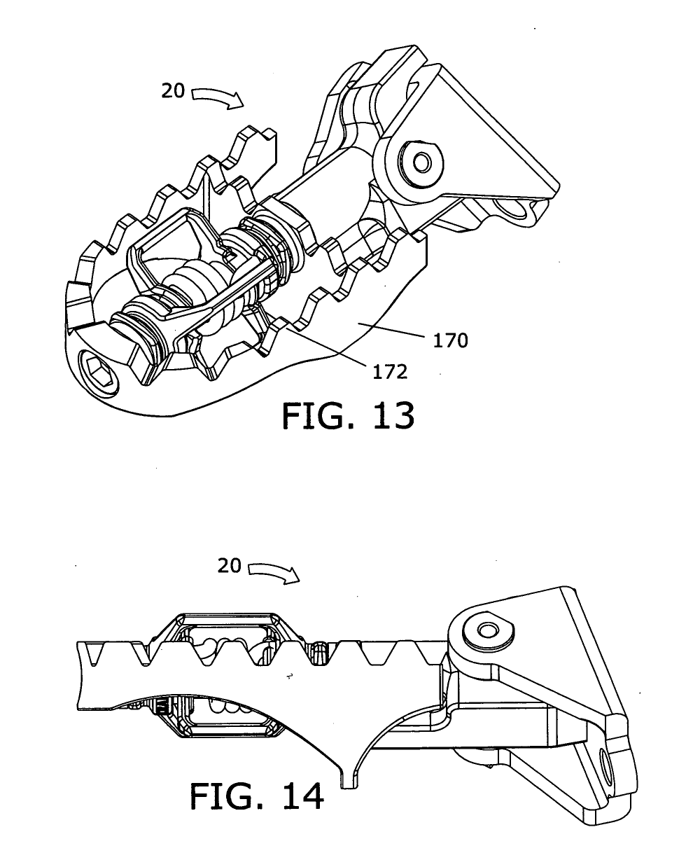

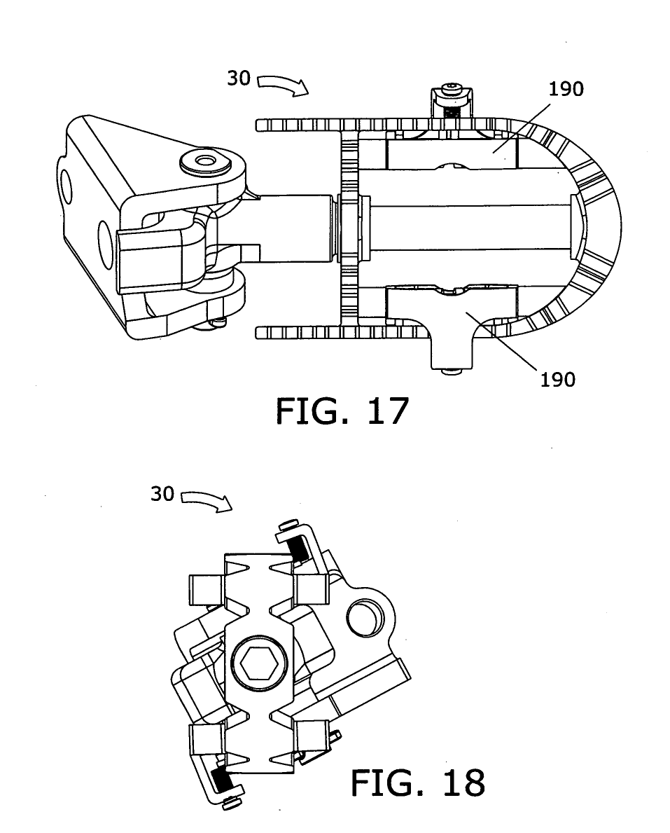

The present invention may be understood by referring to FIGS. 1-19. By way of example, referring to FIGS. 1 to 19, it will be seen that the foregoing and other objects are attained, according to the present invention by a motorcycle foot peg 10, which is comprised of a shaft 90 connected to a bracket 80 via a pin 160, cotter pin 220, platform 140, outer latch 110, inner latch 120, spring 130, and screw 100. Platform 140 swivels on shaft 90. Spring 130 biases outer latch 110 to be held substantially perpendicular to inner latch 120, and swivels on shaft 90. When mounted to a motorcycle frame, foot peg 10 enables a motorcycle rider to fixedly engage into the foot peg via fore and aft cleats 230 and 70 on the bottom of his or her motorcycle boots 40 and 60. To release from the foot peg 10, the rider twists his or her boots 40 and 60 past a certain angle. Platform 140 pivots to expose either side of the platform and make proper contact between the bottom of the boot and the platform. Teeth 142 of platform 140 give grip between the boot and the platform when a rider is not engaged to the foot peg 10. Leg 92 of shaft 90 prevents foot peg 10 from pivoting up and back relative to the motorcycle frame. Alternatively, by eliminating leg 92 and adding a spring, foot peg 10 may be spring loaded so that an impact or force would pivot the assembly up and back relative to the motorcycle frame.

A first cleat 230 is mounted towards the front of motorcycle boot 40. Screws (not shown) secure cleat 230 to the bottom of boot 40. Slots 42 allow cleat 230 to be adjusted fore and aft. For stability when engaged, tread 54 contacts the platform of the motorcycle foot peg. A second cleat 70 is mounted on boot 40 rearward from cleat 230. Similarly, screws (not shown) secure cleat 70 to the bottom of boot 40 through slots 56 and cleat 70 can be adjusted fore and aft. For stability when engaged, tread 58 contacts the platform of the motorcycle foot peg. A rider clips into the forward cleat 230 in order to absorb bumps in the terrain, and clips into the rearward cleat 70 in order to operate the gear shift lever or operate the foot brake. For longer rides, for comfort, it may be desirable to switch between being clipped into the forward and rearward cleats. The rider can also choose to place his or her boot onto the foot peg without clipping in, and will obtain grip between the sole of the boot and the platform teeth 142 of foot pegs 10 and 30, and platform teeth 172 of foot peg 20.

FIG. 1 shows that a motorcycle foot peg 10 is comprised of a shaft 90 connected to a bracket 80 via a pin 160, cotter pin 220 (shown in FIG. 4), platform 140, outer latch 110, inner latch 120, spring 130, and screw 100. Platform 140 swivels on shaft 90. Spring 130 biases outer latch 110 to be held substantially perpendicular to inner latch 120, and swivels on shaft 90. When mounted to a motorcycle frame, foot peg 10 enables a motorcycle rider to fixedly engage into the foot peg via cleats 230 and 70 on the bottom of their motorcycle boots 40 and 60. To release from the foot peg 10, the rider twists their boots past a certain angle. Platform 140 pivots to expose either side of the platform and make proper contact between the bottom of the boot and the platform. Teeth 142 of platform 140 give grip between the boot and the platform when rider is not engaged to the foot peg 10. Leg 92 of shaft 90 prevents foot peg 10 from pivoting up and back relative to the motorcycle frame. Alternatively, by eliminating leg 92 and adding a spring, foot peg 10 could be spring loaded so that an impact or force would pivot the assembly up and back relative to the motorcycle frame. There is sufficient friction between platform 140 and shaft 90 so that platform 140 does not rotate too easily. In this way, platform 140 tends to stay in a relatively horizontal position. The motorcycle foot peg 10 shown is a right foot peg. The left foot peg is a mirror image of the right foot peg.

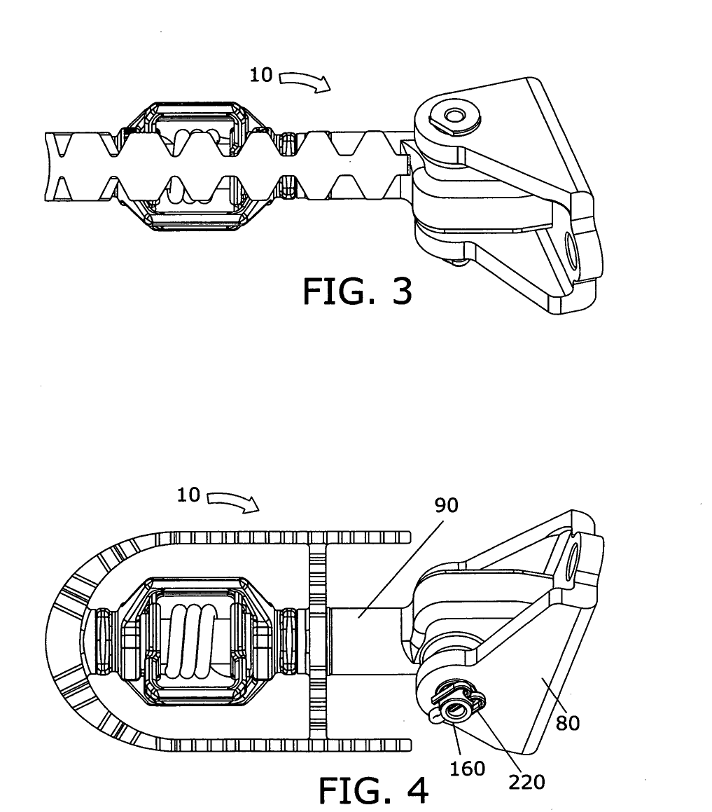

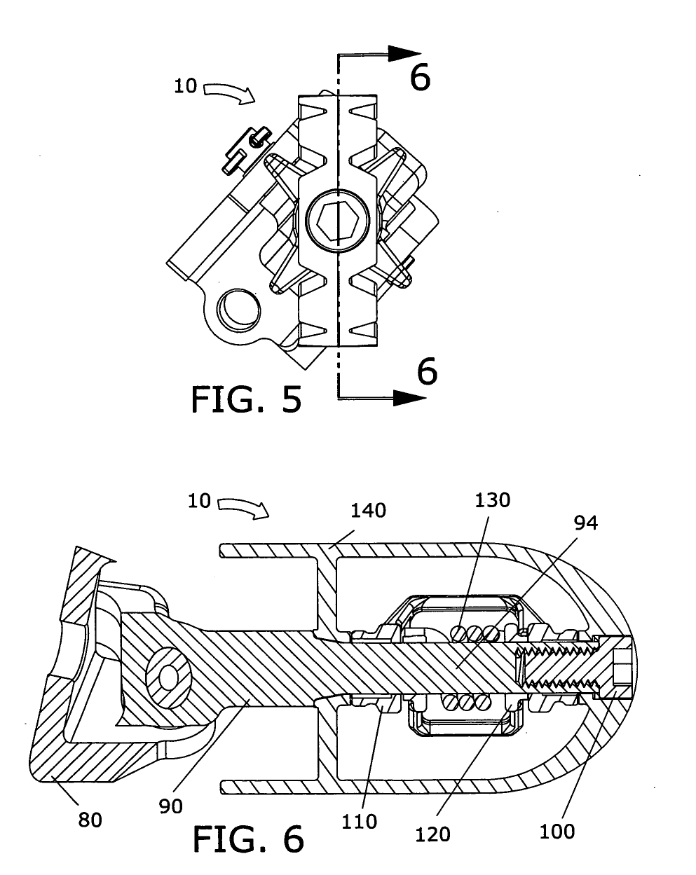

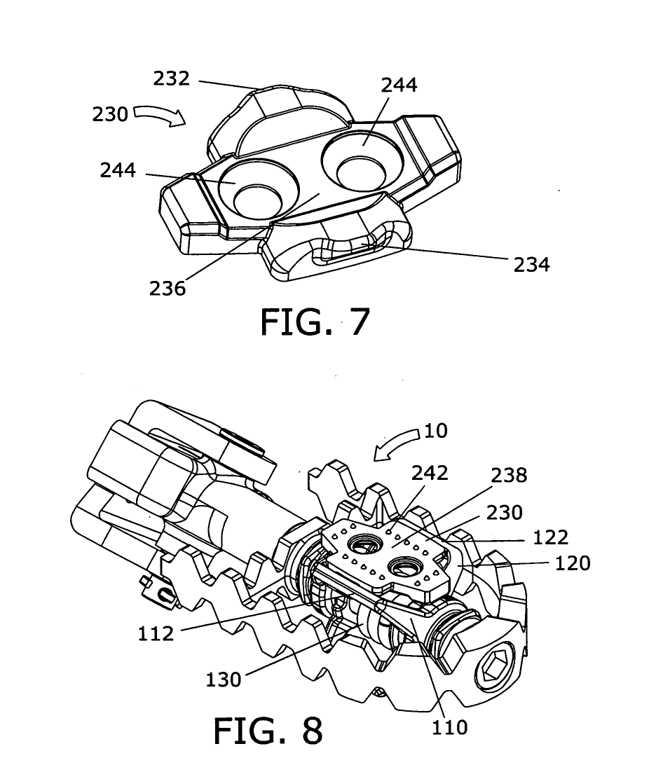

FIG. 2 shows that motorcycle foot peg 10 bracket 80 is screwed to a motorcycle frame through holes 82 and 84. A boot cleat (shown FIGS. 7-10 and 19) engages between bar 112 of outer latch 110 and bar 122 of inner latch 120. Note that outer latch 110 has a second bar 112 and inner latch 120 has a second bar 122 so that there are four pairs of bars that a boot cleat can engage into, depending on the rotational position of the latches relative to the platform. Latches 110 and 120 pivot around support 94 of shaft 90. Platform 140 pivots around support 94 independently of the latches. FIG. 3 shows motorcycle foot peg 10. FIG. 4 shows shaft 90 is connected to bracket 80 via a pin 160. Pin 160 is secured by a cotter pin 220. FIG. 5 shows motorcycle foot peg 10.

FIG. 6 shows that spring 130 biases outer latch 110 to be held substantially perpendicular to inner latch 120, and swivels on support 94 of shaft 90. Screw 100 secures platform 140, latches 110 and 120, and spring 130 onto shaft 90. There can be friction between platform 140 and shaft 90 so that platform 140 does not turn too easily. If desired, various means such as an o-ring could be added to the assembly to create the desired degree of friction, or adjustable friction. FIG. 7 shows a boot cleat 230 having tips 232 and 234, two mounting holes 244, and an upper surface 236.

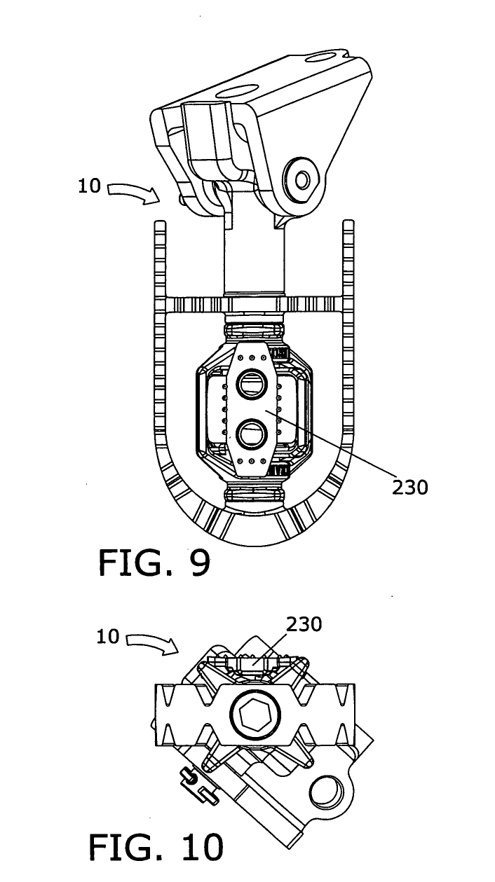

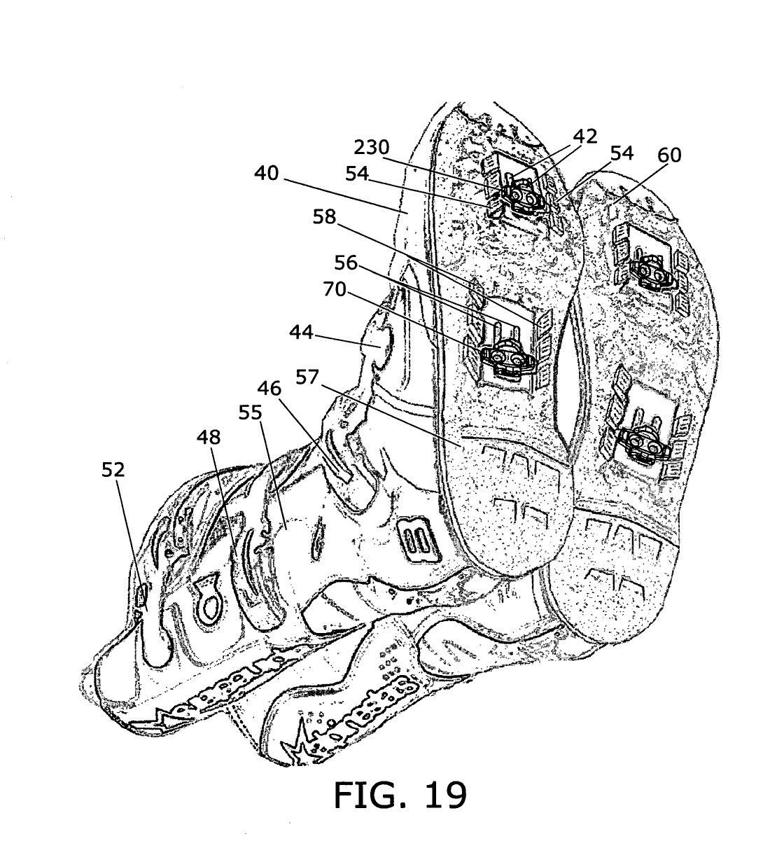

FIG. 8 shows motorcycle foot peg 10 with a boot cleat 230 engaged between bar 112 of outer latch 110 and bar 122 of inner latch 120. For clarity, boot cleat 230 is shown without the boot. In use, the bottom surface 238 of boot cleat 230 would be mounted to the sole of a motorcycle boot (shown in FIG. 19). Pins 242 of boot cleat 230 provide grip into the bottom of the motorcycle boot to make sure that the boot cleat does not slip relative to the boot. Screws (not shown) secure boot cleat 230 to the boot. FIGS. 9 and 10 show motorcycle foot peg 10 with cleat 230 clipped in.

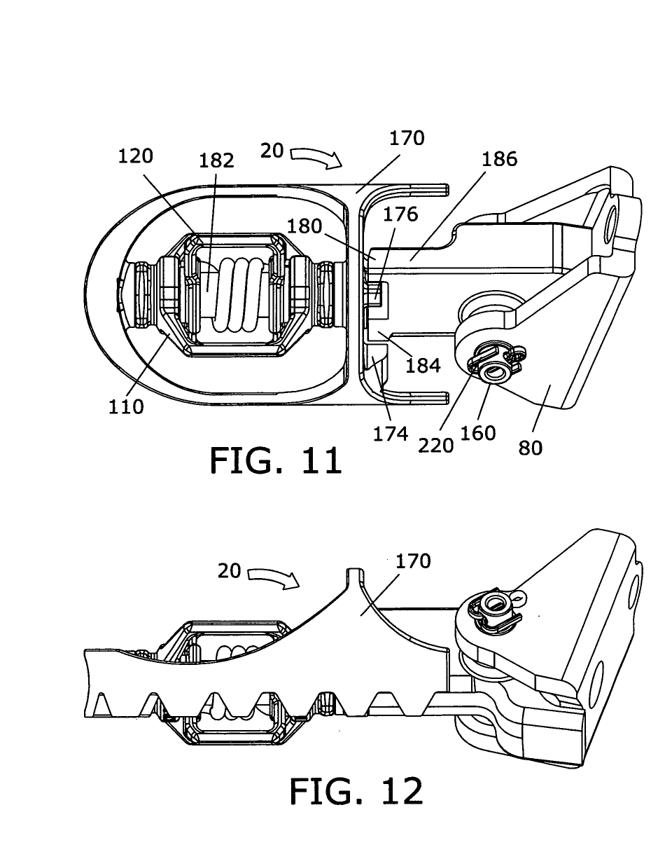

FIG. 11 shows that an alternative embodiment motorcycle foot peg 20 is similar to foot peg 10, except that instead of a two sided and freely rotating platform 140, foot peg 20 has a platform 170 with a single side and pivots through a limited range of motion. Foot peg 20 has the same outer latch 110, inner latch 120, and biasing spring 130, but they are connected to support 182 of shaft 180. Stops 184 and 186 of shaft 180 mate with tabs 174 and 176 on platform 170 to limit the rotation range of platform 170. Shaft 180 is connected to bracket 80 via pin 160 and cotter pin 220. Bracket 80 is mounted to a motorcycle frame. Alternatively, with a small design change, platform 170 could be prevented from rotating at all. The motorcycle foot peg 20 shown is a right foot peg. The left foot peg is a mirror image of the right foot peg. FIGS. 12 through 14 show alternative embodiment motorcycle foot peg 20 shown in FIG. 11.

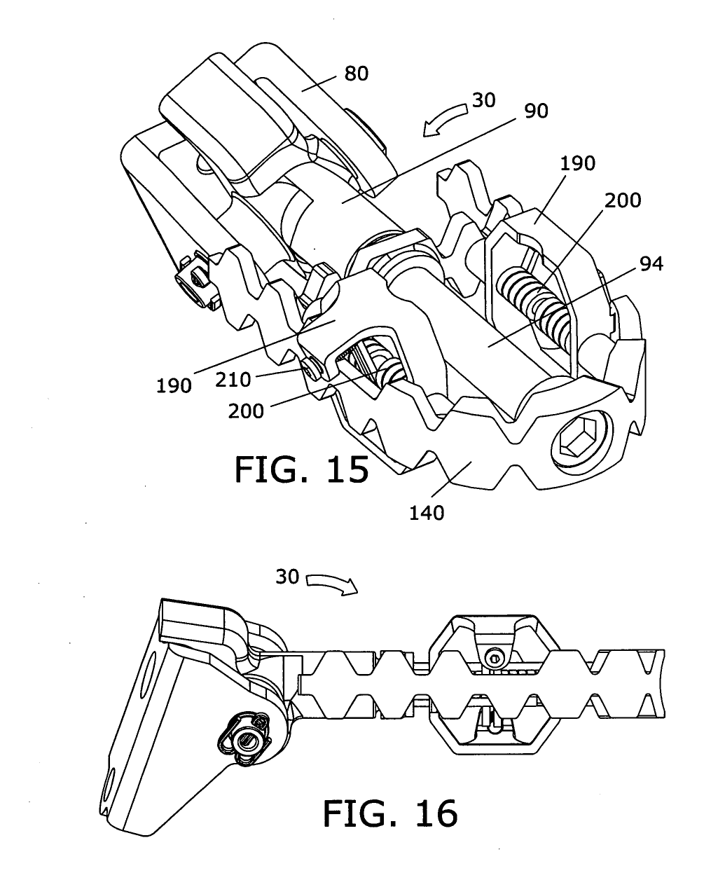

FIG. 15 shows that another alternative embodiment motorcycle foot peg 30 is similar to foot peg 10, except that it uses a different latch mechanism to engage a boot cleat. Latches 190 and 250 are spring loaded by two springs 200. Latch 190 is the same as latch 250 except it is mounted in an upside down and opposite position. When a boot cleat 230 (shown in FIG. 19) is pushed down onto motorcycle foot peg 30, latch 190 spreads apart relative to latch 250 to clamp cleat 230. Platform 140 pivots on support 94 of shaft 90 to allow two-sided engagement. Bracket 80 mounts to the motorcycle frame. Screws 210 adjust the spring load of latches 190 and 250 to customize the feel and function of the mechanism to the rider's preference. The motorcycle foot peg 30 shown is a right foot peg. The left foot peg is a mirror image of the right foot peg. Foot peg 30 could be designed with a one-sided platform similar to foot peg 20. There are also numerous other latching means possible including one where a motorcycle foot peg could engage to a boot cleat. FIGS. 16 through 18 show alternative embodiment motorcycle foot peg 30.

FIG. 19 shows a right motorcycle boot 40 and left motorcycle boot 60 for use with motorcycle foot pegs 10, 20, and 30. Boots 40 and 60 are each comprised of a sole 57 and an upper 55. Upper 55 has buckles 44, 46, 48, and 52 for adjustably securing boots 40 and 60 to the rider's feet. A first cleat 230 is mounted towards the front of sole 57 of motorcycle boot 40. Screws (not shown) secure cleat 230 to threaded inserts of sole 57. Slots 42 in sole 57 allow cleat 230 to be adjusted fore and aft. For stability when engaged, tread 54 contacts the platform of the motorcycle foot peg. A second cleat 70 is mounted on sole 57 rearward from cleat 230. Similarly, screws (not shown) secure cleat 70 to sole 57 through slots 56 and can be adjusted fore and aft. For stability when engaged, tread 58 contacts the platform of the motorcycle foot peg. A rider clips into the forward cleat 230 in order to absorb bumps in the terrain, and clips into the rearward cleat 70 in order to operate the gear shift lever or operate the foot brake. For longer rides, for comfort, it may be desirable to switch between being clipped into the forward and rearward cleats. The rider can also choose to place his or her boot onto the foot peg without clipping in, and will obtain grip between the sole of the boot and the platform teeth 142 of foot pegs 10 and 30, and platform teeth 172 of foot peg 20. It may be desirable to have more than two cleat positions per boot.

We claim:

1. A motorcycle foot peg comprising:
a shaft connectable to a motorcycle frame; a platform for receiving a foot of a rider, said platform being rotatably connected to said shaft; at least one latch for connective engagement with a boot cleat, said boot cleat being mounted to the bottom of a motorcycle boot.

2. A motorcycle boot comprising:
an upper and a sole, said sole having a foot peg cleat for releasable attachment to a motorcycle foot peg.

3. The motorcycle boot recited in claim 2 comprising foot peg cleats mounted in at least two locations on said sole of said boot.

4. The motorcycle foot peg recited in claim 1 wherein said latch comprises four sides for engagement with a boot cleat.

5. The motorcycle foot peg recited in claim 1 comprising a platform of limited rotational movement.

6. The motorcycle foot peg recited in claim 1 further comprising a spring for pre-load adjustment of engagement with a boot cleat.

7. A motorcycle foot peg comprising a clip-in mechanism for securing a boot cleat thereto in selective releasable engagement.

8. The motorcycle boot recited in claim 2 wherein said cleat enables operating the shift lever and foot brake of a motorcycle.

9. A motorcycle, comprising: a frame; and, two opposing foot pegs, each said foot peg having a bracket connected to said frame of said motorcycle, said bracket having a shaft extending therefrom; a platform for receiving a foot of a rider, said platform being rotatably connected to said shaft; at least one latch for engagement with a boot cleat, said boot cleat being mounted to the bottom of a motorcycle boot of said rider.

10. An assembly for use by motorcycle riders; the assembly comprising:
at least one foot peg for connection to a motorcycle; and
at least one boot cleat for attachment to a boot worn by a motorcycle rider;
said foot peg and said boot cleat being configured for releasable attachment to one another to resist separation of said boot cleat from said foot peg in at least one selected direction.

11. The assembly recited in claim 10 wherein said foot peg and said boot cleat are configured for separation from another upon a relative twisting motion thereof.

12. The assembly recited in claim 10 wherein said foot peg comprises a platform for receiving said boot.

13. The assembly recited in claim 12 wherein said platform is rotatable.

14. The assembly recited in claim 12 wherein said platform is rotatable through a limited angle.

15. The assembly recited in claim 12 wherein said platform is fixed.

16. The assembly recited in claim 10 comprising a pair of boot cleats for attachment to a boot worn by a motorcycle rider.

17. The assembly recited in claim 16 wherein said pair of boot cleats are attached to one boot at different locations along the sole of said boot to permit alternative attachment points to said foot peg.
